(19) United States
(12) Patent Application Publication
(10) Pub. No.: US 2009/0302570 A1
(43) Pub. Date: Dec. 10, 2009

(54) Wheelchair wonderbar

(76) Inventor: Kevin J. Davis, Wilmington, NC (US)

Correspondence Address: Kevin Davis, 7101 P Cape Harbor Dr., Wilmington, NC, 28411, US

(21) Appl. No.: 12/156,931

(22) Filed: Jun. 6, 2008

(51) Int. Cl. A61G 5/10

(52) U.S. Cl. 280/304.1

(57) ABSTRACT

A wheelchair guidance system connect-able to a conventional wheelchair for permitting the person guiding the wheelchair to stand beside the disabled person in the wheelchair as he or she guides movement of the wheelchair.

### BACKGROUND OF THE INVENTION

1. Field of the Invention

The present invention is related to wheelchairs for disabled persons, and more particularly to a wheelchair guidance system which is connect-able to a conventional wheelchair to thereby enable the able-bodied person who is guiding movement of the wheelchair to do so at the side of the disabled person, rather than behind him or her, as is the conventional manner of wheelchair guidance.

2. Description of the Prior Art

Wheelchair devices to provide conveyance of disabled persons are well known in the prior art. Wheelchairs have in common a frame, a seat (along with a seat back) connected to the frame for the disabled person to sit upon, two large rear wheels connected to the frame for directly supporting the weight of the disabled person, two front wheels swivel-ably mounted to the frame, support structures mounted to the frame for supporting the arms and legs of the disabled person, and two spaced apart grips connected to the frame at the rear of the wheelchair for being grasped by the person who guides movement of the wheelchair. One grip is provided for each of the left and right hands of the person guiding the wheelchair to thereby enable the person guiding movement of the wheelchair to push, pull and steer by applying selective forces to the grips via his or her hands. Thus, guidance of movement of the wheelchair is accomplished via a person standing directly behind the wheelchair. While wheelchairs have been in existence for a long period of time, there exists no alternative but for the person guiding the wheelchair to walk behind the seat of the disabled person because, whatever grip mechanism is employed, it is always located behind the seat of the wheelchair. This creates an unnatural and strained relationship between the disabled person in the wheelchair and his or her assistant who stands behind, neither person having the benefit of seeing facial expressions of the other as a conversation unfolds between them.

Two conversing people never walk in a single file, they invariably walk side-by-side.

Accordingly, what is needed is a wheelchair in which the person guiding the wheelchair can do so while walking side-by-side with the occupant of the wheelchair.

### SUMMARY OF THE INVENTION

The present invention is a wheelchair guidance system that is connect-able to a conventional wheelchair so as to permit the person guiding the wheelchair to stand beside the disabled person in the wheelchair as he or she guides movement of the wheelchair.

### BRIEF DESCRIPTION OF THE DRAWINGS

FIG. 1 is a perspective view of the invention with assigned parts numbers.

FIG. 2 is a top view of the invention with the three parts designated as sections, A-B-C where part one equals A, part two equals B, part three equals C.

FIG. 3 is a perspective view of the invention included on page 2 of 2 for reference when viewing page 2 of 2.

FIG. 4 is a perspective view of the invention depicting how the invention and a conventional wheelchair may traverse a doorway or confined area, using the first part as a push/pull handlebar.

FIG. 5 is a perspective view of the invention depicting the second and third parts pivoting vertically in unison to demonstrate the pivotal range of motion required to achieve the push, pull, handlebar state of purpose. (See FIG. 6.)

FIG. 6 is a perspective view of the invention depicting the second and third parts folded parallel to the first part as to provide the purpose of a push/pull handlebar.

FIG. 7 is a top view depicting the invention placed on the right side of a conventional wheelchair.

FIG. 8 is a perspective view depicting the invention placed on the right side of a conventional wheelchair.

FIG. 9 is a perspective view of the invention included on page 3 of 3 as a simple reference when viewing page 3 of 3 regarding FIG. 10, FIG. 11, and FIG. 12.

FIG. 10 is a perspective view of the union of the second and third part depicting the pivotal actions of FIG. 4.

FIG. 11 is a side view of the mechanism that permits pivotal rotations as depicted in FIG. 5, FIG. 6.

FIG. 12 is a front view of the first part as described in Claim 1, whereby providing a means for releasably connecting said handle-bar to the handles of the conventional wheelchair.

FIG. 12 is a front view of the first part depicting the means of adjusting the horizontal width of the first part to accommodate a width variable range of 14 to 22 inches with respect to conventional wheelchair handles of which the first part is to be attached.

FIG. 12 is a front view that depicts the written content of FIG. 2, FIG. 3, FIG. 7, FIG. 8 whereby the invention may be incorporated on the left side and/or the right side of a conventional wheelchair.

### DETAILED DESCRIPTION OF THE PREFERRED EMBODIMENT

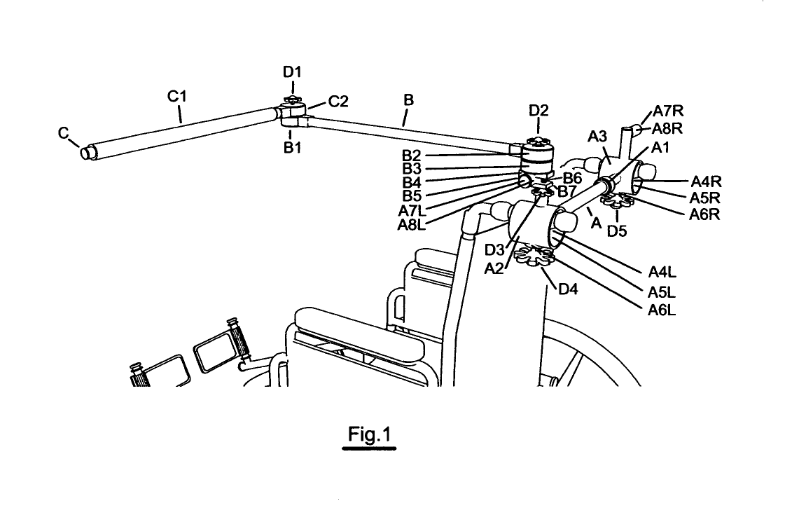

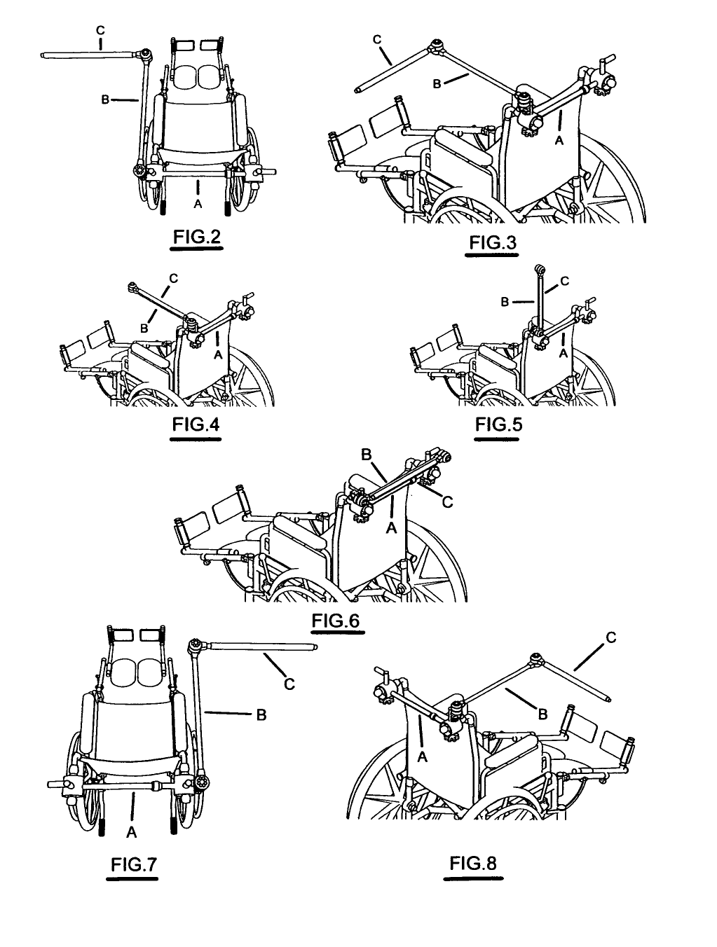

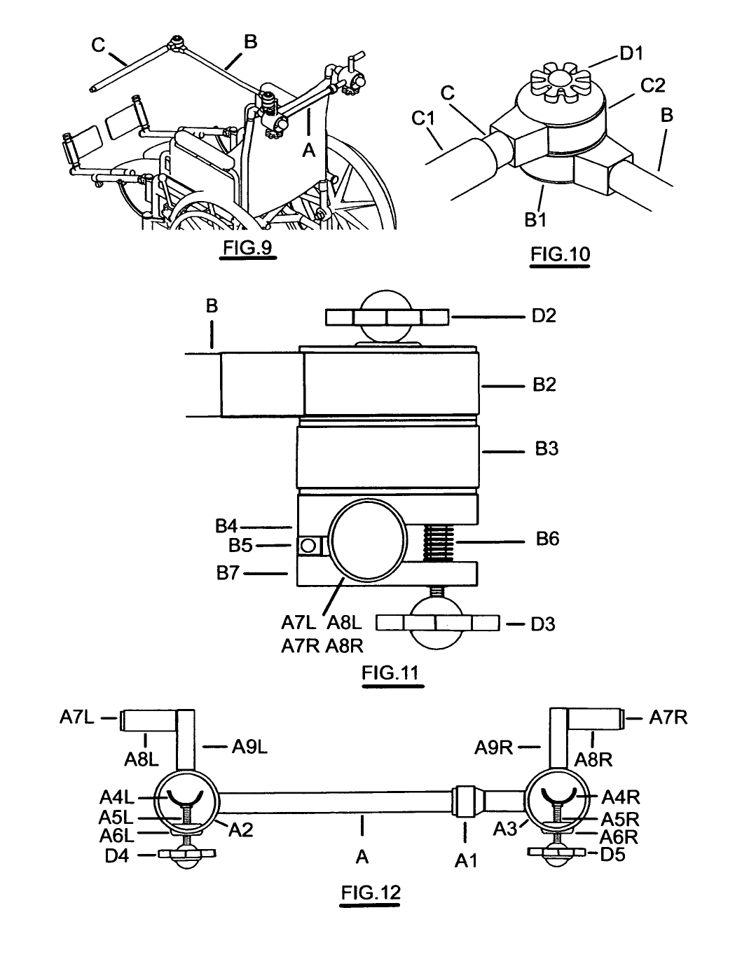

As depicted in FIG. 1 Part C1 may be regarded as a pliable sleeve, inserted over part three, represented as section C, so that the person utilizing this guidance system may have a comfortable grip, to facilitate said wheelchair guidance.

As depicted in FIG. 12 parts A8L and A8R may be regarded as a pliable sleeve, inserted over parts A7L and A7R so that the FIG. 11 mechanism may be provided a means to securely be attached to the first part also designated as section A.

As depicted in FIG. 12 parts A4L and A4R are intended to be a means to attach the invention to conventional wheelchair handles.

The FIG. 12 parts A4L and A4R are a simple split cylinder mechanism, with a pliable area on the top to provide a secure connection of the invention, that may be easily attached or removed, to a conventional wheelchair's handles, without marring or damaging the conventional wheelchairs handles.

The FIG. 12 part A1 represents a means to adjust the invention's ability to accommodate the conventional wheelchair handle width range of 14 to 22 inches.

Physical components of the invention may include but are not limited to plastics, metals and/or wood materials.

Such changes or modifications can be carried out without departing from the scope of the invention, which is intended to be limited only by the scope of the appended claims.

What is claimed is:

1. A guidance system for being connected to a wheelchair, the wheelchair having a right side and a left side, the wheelchair further having a frame, a seat connected to the frame, a seat back connected to the frame, and a rear wheel connected with the frame at each of the right and left sides of the wheelchair, wherein the seat has a front end, further wherein the seat has a rear end whereat is located the seat back, and further wherein the seat defines a horizontal plane and the front end of the seat defines a horizontal axis, said guidance system comprising: a handle-bar; and means for releasably connecting said handle-bar to the conventional handles of the wheelchair, so that at least a portion of said handle-bar extends from one of said right and left side of said wheelchair in an orientation substantially normal to the frame of the wheelchair in a direction substantially parallel with respect to the horizontal axis and in a plane substantially parallel with respect to the horizontal plane, at a location substantially adjacent the front end of the seat; wherein the wheelchair may be movably guided by a person grasping said handle-bar while the person is located beside the seat at said one of said right side and said left side of the wheelchair.

2. The guidance system of claim 1, wherein said wheelchair guidance system according to the present invention is composed of a handle-bar. The handle-bar is composed of three portions, a first portion which attaches to the conventional handles of the wheelchair, comprising an adjustable range of 14 to 22 inches, a second portion bent at 90 degrees to the first portion so as to generally comprising an adjustable range of 14 to 22 inches, a second portion bent at 90 degrees to the first portion so as to result in a member that may be gripped by a person who guides movement of the wheelchair.

3. The guidance system of claim 2, wherein said third portion of the handle-bar is pivot-ally connected to the second portion of the handle-bar, so that the third portion of the handlebar may fold inward, becoming parallel to the second portion permitting the existing wheelchair and the guidance system to traverse through a doorway or a confined area.

4. The guidance system of claim 3, wherein said second and third portions are pivotal in unison as to be parallel to the first part resulting in a push and/or pull handlebar feature that may be gripped by a person who guides movement of the wheelchair.

5. The guidance system of claim 4, further comprising said second and third part are designed to be attached to the left side and/or the right side of a conventional wheelchair to accommodate situations where the occupant of the wheelchair may suffer from a visual or auditory impairment on the left or right side of their person.
